(19) United States
(12) Patent Application Publication
(10) Pub. No.: US 2012/0208634 A1
(43) Pub. Date: Aug. 16, 2012

(54) System and Method for Enabling Social Health Networks for Population Managers

(75) Inventors: Jeff Cohen, (US); Kendall Thiessen, (US)

(73) Assignee: Welltok, Inc.

(21) Appl. No.: 13/398,457

(22) Filed: Feb. 16, 2012

Related U.S. Application Data
(60) Provisional application No. 61/463,513, filed on Feb. 16, 2011.

(51) Int. Cl. G06F 15/16; A63F 9/24

(52) U.S. Cl. 463/29; 709/204

(57) ABSTRACT

A system and method for using social tools, such as social media, to engage one or more members of a healthcare ecosystem that includes: tools for enabling sharing content from an identified source, posting of content from an anonymous source, anonymously linking a member to one or more third party stakeholders (health insurance companies, physicians, organizations, employers), and one or more contests and rewards for providing incentives for behaviors promoted by third party stakeholders, and a reporting tool for use by the third party stakeholders for assessing the effectiveness of the contests and rewards, both on the group and individual level, to achieving those behaviors. All of this is provided within a framework that is available on personal computers, tables or mobile phones.

### RELATED APPLICATIONS

We hereby claim priority from provisional application No. 61/463,513 entitled “A System and Method for Enabling Social Health Networks for Population Managers” filed on Feb. 16, 2011.

### BACKGROUND OF THE INVENTION

Healthcare and delivery of healthcare currently accounts for more than 16% of the GDP of the United States. Insured patients are naturally less concerned about health care costs than they would if they paid the full price of care. The resulting moral hazard drives up costs, as shown by the famous RAND Health Insurance Experiment. Insurers use several techniques to limit the costs of moral hazard, including imposing copayments on patients and limiting physician incentives to provide costly care. Insurers often compete by their choice of service offerings, cost sharing requirements, and limitations on physicians. Brook R H, Ware J E, Rogers W H, Keeler E B, Davies A R, Sherbourne C A, et al. “The effect of coinsurance on the health of adults. Results from the RAND Health Insurance Experiment.” Santa Monica, Calif.: RAND Corporation, 1984.

This seminal study opened the door to an increasingly cost shift to consumers. Co-pays and other mechanisms became a critical tool for managing cost and reducing unnecessary care. Unfortunately, many of these same features also discouraged consumers from securing very necessary care in many instances. This problem is only exacerbated by the fact that many consumers do not trust insurance companies and as a result may fail to disclose or otherwise fail to test themselves for potential life-threatening illnesses for fear that they will be dropped. In other words, the current system is cost-shifting in a way that often creates the wrong incentives for consumers, and with no effective means for communicating honestly with population managers, it is difficult to engage them in a conversation to create better outcomes.

Another fundamental problem is that consumers in health care markets often suffer from a lack of adequate information about what services they need to buy and which providers offer the best value proposition. This confusion has been heightened by the fact that many insurance policies are extremely long and complex documents and consumers are often unable to understand their benefits, costs or other incentives that insurers and other population mangers may offer. In other words, not only are consumers increasingly trying to reduce their own costs and making suboptimal decisions, they are doing it with a complete lack of understanding of the financial consequences of their decision.

Finally, because of the lack of trust and transparency between patient and the various healthcare stakeholders, such as insurance companies, it is extremely difficult if not impossible to measure the efficacy and desirability of one or more incentives that they may offer to rectify the gap between outcomes and incentives. This makes it very difficult to effectively construct a more effective health management regime. In sum, the market efficiency is being hampered by a lack of trust, a clear way of communicating among key stakeholders and lack of effective engagement tools for supporting good consumer behaviors.

What is needed, then, is a system for engaging incenting consumers that does not reduce the likelihood that they will seek treatment by providing clear incentives that encourage the right behaviors, providing timely and personalized information about their benefits such that they can choose their own treatment options more intelligently and a platform for enabling this conversation in a safe, secure and anonymous way such that a consumer can feel comfortable sharing this highly personal information with Stakeholders and Population Managers. What is also needed is a platform for collecting, parsing and reporting behavior and other user data back to the various stakeholders (physicians, insurers, family) and then leveraging that feedback to better optimize consumer management, engagement tools and resulting health outcomes.

### BRIEF DESCRIPTION OF THE DRAWINGS

FIG. 1 provides a block diagram illustrating the system of the present invention;

FIG. 2 provides a block diagram illustrating the components used to register a member;

FIG. 3 illustrates the components of the privacy management module of the present invention;

FIG. 4 illustrates the methods that can be used for a member to communicate with a server configured in accordance with the present invention including anonymoity filter;

FIG. 5 is a block diagram illustrating the content platform of the present invention;

FIG. 6 is a block diagram illustrating the components of the Social Health Infromatics Reporting Engine of the current invention; and

FIG. 7 illustrates the feedback mechanism of the current invention, which can be used to optimize one or more user behaviors in response to interaction with the content platform and information collected by the Social Health Informatics Reporting engine.

### DETAILED DESCRIPTION OF EXAMPLE EMBODIMENTS

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

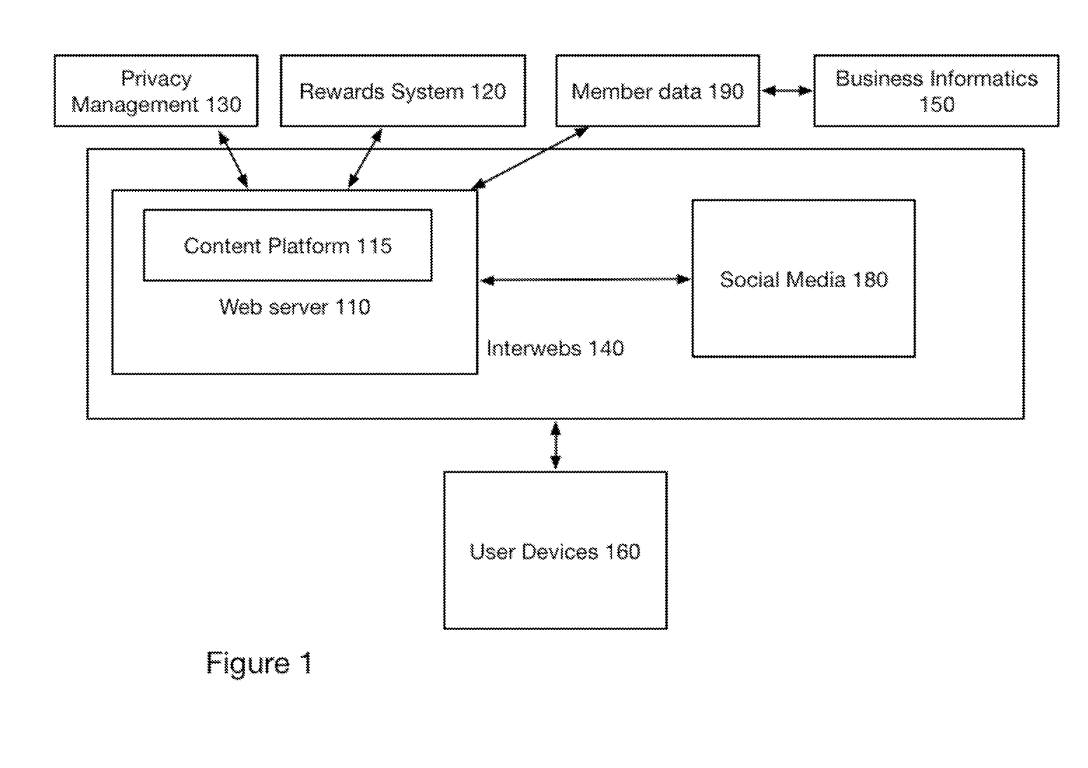

Referring now to FIG. 1, a system drawing of the present invention—along with one or more optional components—is shown. Web Server 110 stores all necessary web pages and other network documents and images that are used to provide an interface to one or more aspects of the present invention. This includes, without limitation, pages for registering one or more accounts, getting account status updates such as account balances and reward balances, and for generating one or more electronic reward codes. The Web Server is either directly connected or otherwise available for communication with any device on the Internet 140, A Rewards System 120, the Privacy Management System 130, Social Media 180 and the Social Informatics Reporting System 150.

User Devices 160 are electronic machines that include a processor and software that is capable of interfacing with the Internet 140 via one or more communications interfaces, such as internet web browser technology, mobile applications, or other software that enables two way communications with the server.

Devices 160 that can be used by a user in connection with the service can include computer Devices, cell phone devices (such as iPhones™ or Blackberry™ devices), or kiosks/terminals that include an interface and enable the retrieval of one or more pages or information from the Web Server 110 via the Internet 140. Preferably, cell phone devices 106b further include location-transmitting means such as a GPS or other input that enables a user to send their current location to the Web Server.

Social Media 180 is the collection of web services and websites that are configured to permit users to post or otherwise transmit information about themselves and otherwise publish and share information on a one-to-many basis in near real-time. Common examples of Social Media include Facebook™, Twitter™, Friendster™, Yelp™, Linkedln™ and other similar networking sites. In each case, these services permit users to share or otherwise post information relating to their status or relating to recent activities. Examples could include status updates as simple as “went for a run” or could include more relevant and/or contextual data via one or more associated links or other data sources.

Rewards System 120 is a process or device that is configured to manage one or more programs that reward one or more user behaviors in connection with their use of the system or their activities outside of the system that are reported to the system. The rewards system 120 is in communication with the Internet 140, Social Media 180, the Notification System 124, and the Billing System 108. The Rewards System 120 can manage rewards using any number of common reward accounting approaches including points based systems (accumulating one or more “reward points” such as those used by the airlines), drawing type awards (being entered one or more times in a reward drawing based on performing one or more reward actions within the award term), coupons (receiving one or more benefits in connection with a future financial transaction or purchase), or any number of other reward configurations.

In one embodiment of the present invention, the Rewards System 120 is configured to grant users a discount in connection with the actions of both the user as well as one or more friends that may be linked to such user via Social Media 180. The Rewards System 120 could both receive information and monitor one or more Social Media 180 platforms to retrieve data or information posted by one or more friends or users on such Social Media 180. In the preferred embodiment, this information would be retrieved by the Web Server 110 in communication with one or more additional internet connected services (not shown) and extracted from social media 180.

The rewards system 120 and Web server 110 could further be impacted by the feedback loop 195 from the business informatics 150 that results from the Member Data 190. For example, if a stakeholder, such as a population manager, desires to see a certain number of members participating in their weight loss contest, the “adoption rate” of Members into the contest could drive adjustments to the Content Platform 115 (such as larger links to the contest or higher page placement) which could further impact the Rewards System 120 such as by increasing the offers of one or more incentives, ranting more points or other benefits that will increase adoption. Likewise, increased adoption may mean reducing benefits.

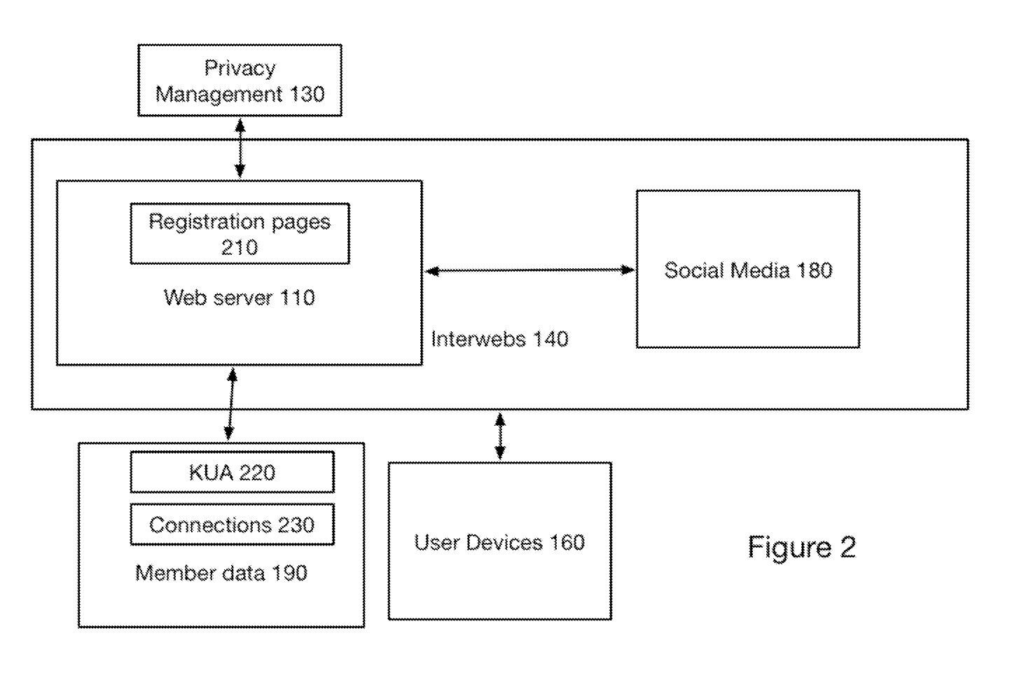

Referring now to FIG. 2, a block diagram illustrating the components for registering with the system illustrated in FIG. 1 is shown. The registration method may occur along three possible paths. In each case, the objective is to allow the user to register, enter any key attributes about their profile and, if desired, associate with one or more of their healthcare stakeholders (“Stakeholders”).

In the first step, a user would use one or more User Devices 160 to connect to the Web Server 110 via the Internet. The Web Server 110 includes registration pages 210, in communication with the privacy management engine 130 and Member Data 190.

Registration could be performed by manually entering fields of data via one or more Registration Pages 210 or could also be accomplished by a “single sign on” with one or more existing profiles that may be already configured in Social Media 180. For example, a user may elect to “sign on” using their Facebook™ profile and authorizing the web server 110 to make API calls needed to complete one or more registration fields. This could also be used to identify any existing members of the service that may already be connected to the user via one or more Social Media services 180.

User attributes are gathered during the registration process and could include any number of key attributes including disease state, primary care physician, adherence to treatment protocols, annual medical costs, medial history, family history, dependent information, employer group and industry classification codes. These will described collective as key user attributes (KUA) 220. As explained above, this could be entered by the User directly or could be extracted from one or more servers that already have data on the user including other social media sites or health information exchanges. Other than Social Media 180 and User entry via one or more Registration Pages, another means for acquiring KUA 220 about a user can also be achieved via one or more Connections 230.

In the preferred embodiment, the system permits Connections to (at least) the following Stakeholders:
Other members of the site such as friends, family or other personal relationships. Connecting with other members enables many of the social aspects of the present invention and is optimized by leveraging any existing relationships that the User may have with other members on external Social Media 180 sites as well as members that they may elect to connect to via the system
Healthcare providers such as physicians, health and wellness coaches, trainers, or any other participants that assist in the delivery of care
Health insurers, governmental programs or other financial services providers that assist in the financing and reimbursement of one or more health services (referred to collective as “Population Managers”)
Communities of Interest or other “group” pages that have been developed to provide health and wellness information based on a particular interest (weight loss, jogging), a particular condition (diabetes) or other KUA shared by the users (location, age)

Once a user selects a stakeholder for a connection, that Connection 230 is then stored in the Member Data. As will be explained further below, each Connection 230 can have a dynamic impact on the content a user sees on their personalized web pages, the services that are authorized (including games, contests, incentives) and the pages that they may access (such as pages constructed for members of a particular weight loss) program or that otherwise only work when you share a Connection 230 with one or more Population Managers.

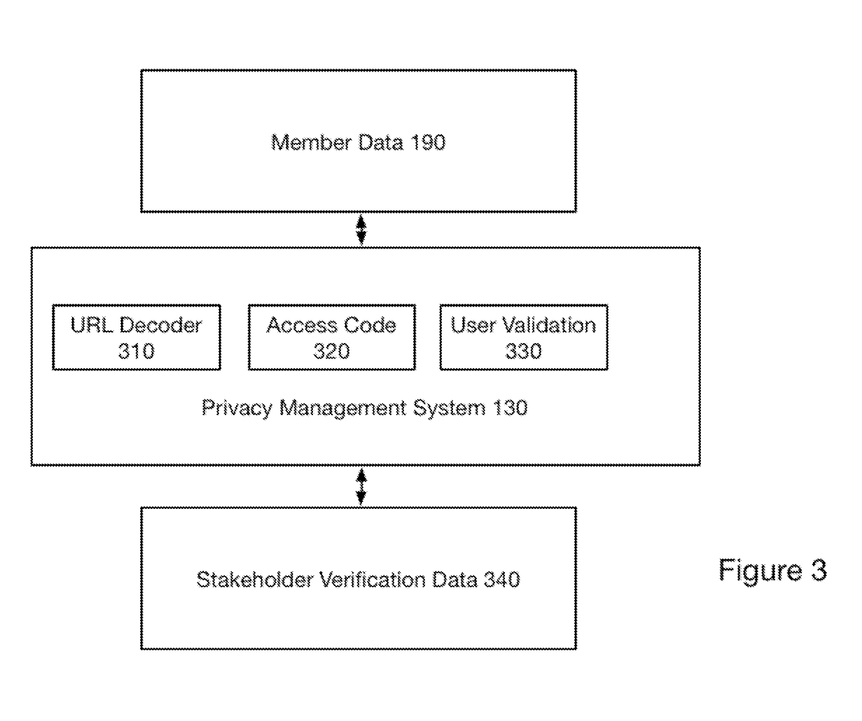

Referring now to FIG. 3, a diagram illustrating the Privacy Management module 130 of the present system is shown. The Privacy Management system 130 is the collection of functions that permit a user to perform one or more services on the system without revealing their personal identifiable information (“PII”). This includes very simple features such as mapping a user profile into one more alternative user names (a so called user “handle”) that may have been entered during registration or could include totally cloaking a user under an “anonymous” user name. These features are well understood in the art.

Such traditional means are effective for privacy but use of the system is optimized for Users that establish one or more Connections. As a result, the Privacy Management Module 130 includes one or more submodules that permit a User connect to Stakeholders in various ways ranging from completely anonymous, to semi-anonymous, to private and ultimately public. Furthermore, each privacy level can be applicable for the users entire profile or any portions thereof.

In the preferred embodiment, the Privacy Management Module 130 includes at least three submodules: a URL encoder/decoder module 310, an Access Code Module 320 and a Validation module 330. In each case, the submodules communicate with a server (not shown) that stores at least one Stakeholder Verification Data element to confirm the actions and information received by the appropriate submodules 310, 320, 330.

### URL Encoder/Decoder 310

In this embodiment, the certification begins when a user clicks on one more more encoded URLs. This is generally a code or URL given to the User by a stakeholder such as via electronic mail, a special member only page, or via other means such as an SMS delivered to the Users mobile address. If selected by the User, the unique hyperlink will take the user to one or more registration page(s) and will call the URL Decoder subroutine the unique URL code. The URL decoder 310 will then call the Stakeholder Verification data 340 to determine which Stakeholder is associated with that URL value. If the URL value matches at least one stakeholder in the Stakeholder Verification Data 340, then the Member Data 190 is updated to include this stakeholder in their list of Connections 230. As explained above, each connection in a Member's profile can impact what features they receive, which pages they can access and other services that may be linked to one or more Stakeholders.

### Access Code Converter 320

In an alternative embodiment (or an additional embodiment), Stakeholder Verification Data could also include a special access code that is not expressly linked through a URL. In a very similar process, a User may update their Member Data 190 via a link, such as a “Account Settings” page that permits the additional of one or more connection. If a member enters an access code, the system would make a call to the Privacy Management System 130 and specifically the Access Code submodule, with the entered code. The Access Code module 320 would then compare the code to the Stakeholder Verification Data 340 to determine if the code matches any of the Stakeholders. Again, upon verification of the access code, the Member Data 190 would then be updated to include the associated Stakeholder in their list of Connections 230.

### Validation 330

User data validation requires the user to enter a unique personal data attribute (such as a KUA 220) during the registration process and call out to the User Validation Module 330 to determine if the KUA is a match for any members in the Stakeholders member data. The User could enter this information during registration and automatically permit connections based on this data (i.e, automatically connect to stakeholders that identify the user as a member) or it could identify a stakeholder at any time during use or registration and ask that the connection be validated. In this example, the User Validation Module 330 would first make call to the Stakeholder Verification Data 340 and determine which KUA will be required to validate. The system would then use previously entered Member Data 190 to provide the appropriate KUA. The User Validation Module 330 would then use the KUA 220 to compare it against the Stakeholder Verification Data 340.

While these various modules have been described as alternative methods for verification, they can be combined in various ways to improve the accuracy of the connections. For example, the User may need to receive the correct URL and, on the page retrieved via the URL, be asked to submit a KUA 220 or special access code to verify the connection. Other factors could also be relevant. For example, a URL may only be valid for certain periods, or certain times or for members that are located in specific geographies. For example, Colorado Health Plan may only permit verification from machines that are based on an Internet Protocol (IP) address located in Colorado.

The means for verification may also have an impact on the level of “trust” attributed to the connection and therefore the level of services granted to the User from the Stakeholder. For example, if a User was verified using a URL, the verification could be rated as “low” since a URL could be shared with non-members (such as via a forwarded email).

Furthermore, while the connections have been described in terms of a relationships between the two parties, the user may elect to have different types of connections: a synchronous connection or an asynchronous connection. In the case of a synchronous connection, it may also be private or public. In the preferred embodiment, the system has a “trusted” registration section that allows the user to select or configure the level of verification with the Stakeholder and further opt-in to each of these connection types.

This flexible and dynamic framework is a critical component of establishing a safe and trusted way to encourage connections in a way that facilitates important member communications without feeling vulnerable to misuse of personal health by one or more Stakeholders. The system of asynchronous communication further permits a Stakeholder to get member-driven aggregate data to help improve incentives, offers and other benefits even if a Member may not want to reveal their personal information or online activities.

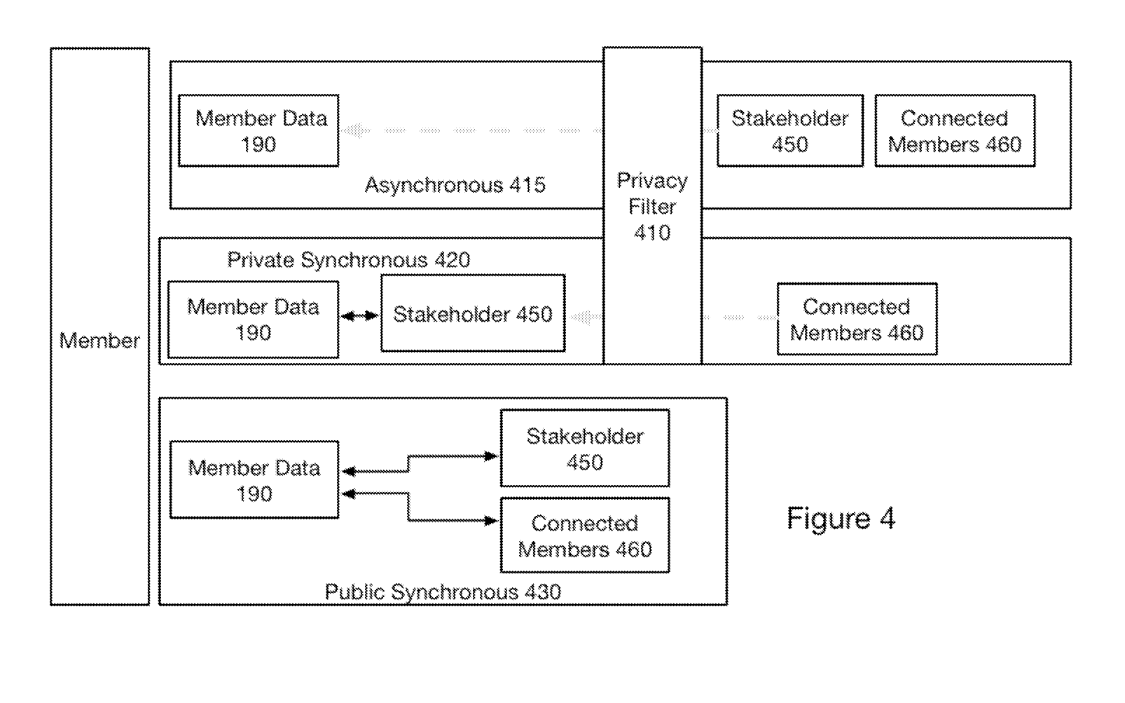

Referring now to FIG. 4, a sample of three connection types supported by the present invention is shown. The first of this is asynchronous 425. In an asynchronous connection 415, a user chooses to connect to a Stakeholder 450 but keeps their identify—and therefore the fact that they are connected—secret from both the stakeholder and other members 460 that are connected with the Stakeholder 450. In this case, while the system will allow the user to access one or more features associated with the stakeholder, it would not allow the stakeholder to personally identify the user or otherwise access any Member Data 190. For example, let's take a sample user Bill. Bill is a member of the United® Healthcare plan but he is concerned that his activities on the system—which can include such things as blogging, reading articles, accepting challenges and other content—might negatively impact him as the insurance company could choose to drop him, raise his rates or any number of other concerns. On the other hand, he knows that there are many valuable programs that are available via United and he would like to better understand how his health decisions could impact his coverage.

In this instance, he could verify the connection using the methods outlined in FIG. 3 and then could choose to make the resulting connecting asynchronous. In such case, the system will provide him with access and content associated with the Stakeholder 450 but would make all of his posts, his activities and his replies totally anonymous to the Stakeholder 450 and other Members 460 that are linked to the Stakeholder 450. This is achieved by having all communications transmitted through a privacy filter 410 that removes any identifying information—such as user names—and replaces them with anonymous codes and/or identifying information. In one embodiment, this might include an “Anonymous User Tag” (AUT) that can be assigned to the Member and associated with all of his actions.

Another alternative connection type if Private Synchronous 420. In this case, following verification of the connection, the Stakeholder would be able to see and access any Member Data 190 as part of their connection but any activities that the Member may perform on the pages or content associated with the Stakeholder would be “anonymized” for any other Connected Members. An example of this scenario might be a stakeholder that is a physician. In such a case, a Member may be very comfortable sharing his identity with the physician but would not want other Connected Members 460 to know that he is connected and/or otherwise know what content he is posting. The advantage of such a scenario is obvious: by providing a safe place for a member to connect with a physician, he/she can share information that everyone can see but only the physician can link to a private identity (i.e. one of his patients) Similarly, if other patients are Connected Members 460, they can also gain value from his replies and responses to concerned patients without compromising privacy and without requiring him to reply privately. This process can enable a very rich dialogue, provide the physician with information that can help him better manage his patient while still enabling the fruits of his labor (i.e. replies that he drafted to a member) to be published and available for use by other members.

The final connection type illustrated in FIG. 4 is public synchronous. In this example, the connection made is synchronous and is publicly known by other Connected Members 460. An example of this connection might be a diabetes patient that wants to participate in a community of people that have diabetes. In this case, they may feel very comfortable or even empowered to share their identity as part of helping develop a more public support network. In this case, all communications or content posted on the pages maintained by the Stakeholder 450 would be visible to all Connected Members 460.

While we have described three possible connection types, many other connection types are also possible. For example, an asynchronous, semi-private connection may permit members that are directly connected to the User (such as family members) see a connection to a Stakeholder but not allow the Stakeholder to see who they are connected to. In this way, the User could remain anonymous relative to the Stakeholder but a small circle of private contacts would be authorized to “see” the Connection.

Another possible type is synchronous, semi-private. In this instance, the Stakeholder and Member would be connected to each other but only select members would be invited into knowledge of the connection. For example, Bill may wish to permit his caregiver and “invite them in” to the connection he has with his physician. In this way, any communications shared between the two would be available to the members that have been specifically invited into this connection. This would be particularly useful in the case of a caregiver who might need to understand and participate in these important conversations without either having to use the member's account and login information to read the messages without also having to make them publicly available to all members.

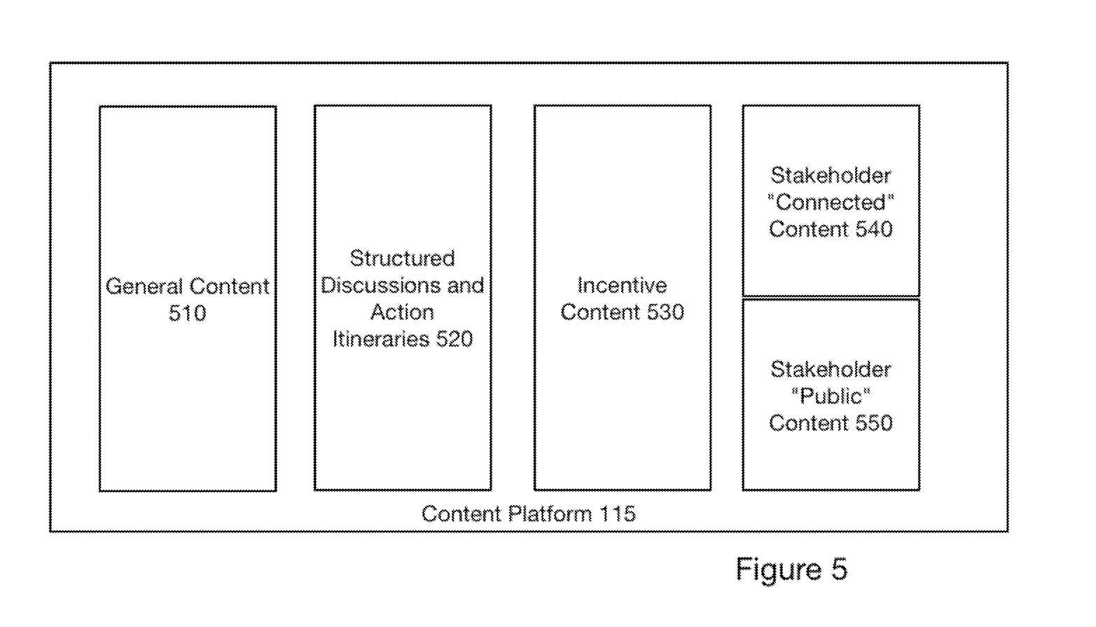

Referring now to FIG. 5, the Content Platform 115 of the current invention is shown. The Content Platform 115 is stored on the Web Server 110 and provides the interface, content, articles, challenges, games, blogs and other materials that can be used to education, incentivize and optimize the health of the member. More specifically, the Content Platform 115 is composed of 5 key components: General Content 510, Structured Discussion 520, Incentive Content 530, Stakeholder “Connected” Content 540 and Stakeholder “Public” Content 550.

General Content 510 is the content that a member would receive and get access to immediately following registration. This might include general information about healthcare, articles, checklists and other content that is of general interest to the community. While members could have access to any of the General Content, the system can be further optimized to provide unique links or access to those portions of the General Content 510 that is more likely to be applicable to a given member. This can be based on self-selection (an indication that they are interested in receiving general information about healthy cooking, for example) or could be based on one or more KUA such as their age or disease state. For example, a user may receive more links to content that the system has determined are of interest to older members. The actions of the member on the Content Platform 115 (regardless of which component is engaged) could also be used to optimize the member experience. In essence, using member activities to help create a “social health fingerprint” of the member and try and optimize content relative to that fingerprint. There are a number of engines that have been developed to help leverage user data to create such a fingerprint.

The Content Platform 115 further includes structured discussions. This could be structured for condition, symptoms, or other health status using tools such as ICD 10. Alternatively, the groups could be structured and mapped to the business processes and functions of a specific type of Stakeholder. For example, in the case of a structured discussion group around back surgery, there could be different groups structured for different stages of the process (pre surgery, recent surgery, post surgery, long term recovery). In the case of a discussion group around health reimbursement, discussion groups could be structured to match the business processes being employed by Population Managers, such as enrollment, pre-certification, claim submission, claims resolution.

A similar structure or approach can also be used for Structured Action Itineraries (“SAI”) 520. Structured Action Itineraries 520 are content “pathways” and interactions that are recommended to specific members and could be configured based on any number of factors including their personal information, user activities on the site, previously identified desired outcomes, or based on the Stakeholders with whom they have a connection. For example, a Structured Action Itinerary 520 for someone desiring weight loss may include weekly “healthy cooking” suggestions, daily reminders regarding physical exercise, a subscription to a discussion board of other people trying to lose weight and an invitation to a special offer from a Stakeholder with specialized expertise and interest in weight loss.

In each case, the member's reaction and compliance with an SAI is tracked and provides insights into best practices for utilizing social networking characteristics to manage and track populations. In a preferred embodiment. an SAI can also be mapped to a Stakeholders processes, such as an insurance company connected to the Member, and can be used to optimize managing and track preferences and behaviors. Additionally, SAIs may be designed for general use or may be included in Stakeholder Connected Content 540. In this way, a Stakeholder, such as a population Manager, can build out multiple SAIs and determine which are the most effective in general or broken down by specific demographics such as geography, age, sex, orientation or other factors.

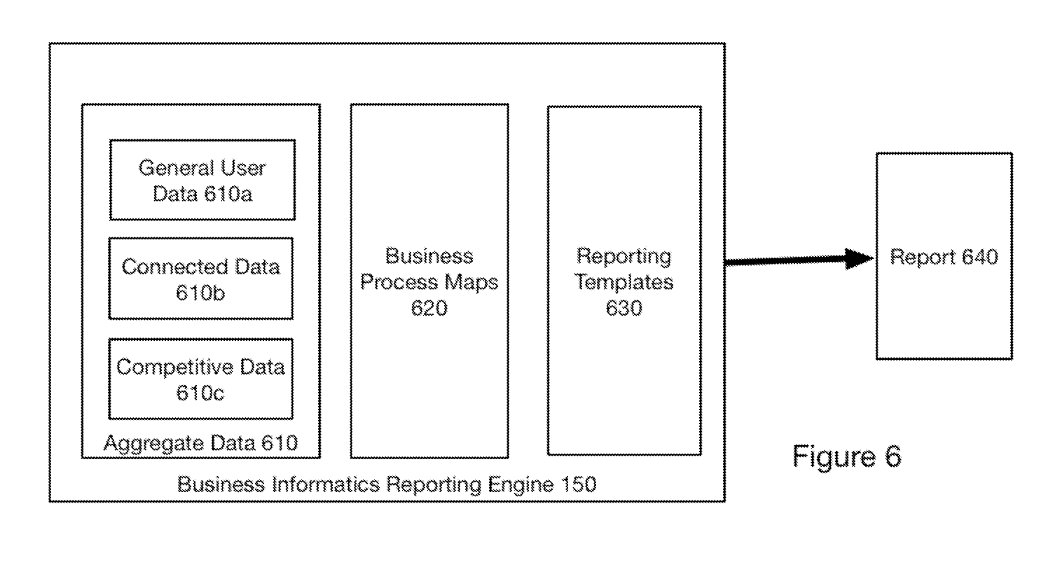

Referring now to FIG. 6, a block diagram illustrating the components of the Social Health Informatics Reporting Engine 150 is shown. The Social Health Informatics Reporting Engine 150 is comprised of three primary parts: Aggregate User Data 610, Business Process Maps 620 and Reporting Templates 630.

Aggregate User Data 610 is the raw information that is of interest to the Stakeholder (or other report recipient) and generally includes three distinct types of information: data across all users that register with the service (“general aggregate data”), data across all users that are connected (whatever connection type) to the Stakeholder (“connected data”) and data regarding the members, connections and efficacy of similarly situated stakeholders that are registered with the system (“competitive data”).

General aggregate data 610a is just that—data on the general members. This could include page clicks, average visits, length of visits to a page, number of members reached, number of members registered, or any number of generate data that can be collected and monitored by any web server.

Connected Data 610b is data and information based on members that have elected to connect to a given Stakeholder. This data is uniquely valuable as it is the data that is expressly linked to the efficacy of the Stakeholder. One of the primary benefits of the multi-type connections supported by the present invention is that a member need not reveal themselves to the stakeholder to provide general relevant and actionable data to the Stakeholder. Because the connection has been authenticated, the value of the connected data is even more valuable. Finally, because the Stakeholder can modify or configure the Content that they provide on the Content Platform, they can structure discussion groups, incentives, SAIs and other components of their “connected” content in a manner that maximizes the value of the Connected Data 610b.

Competitive Data 610c is using the aggregate connected data of one or more competitive stakeholders (for example, competitive insurance companies) to enable a given stakeholder to see how their programs, content SAIs and other program benefits measure up. This data can also be modified to compare only stakeholders that have developed similar engagement tools. For example, United™ healthcare might get aggregated data for Members connected to other large insurance companies that sponsor content on the system and have rolled out similar programs and incentives. In this way, United can assess the efficacy of its programs and also adjust them to reflect best practices.

The second component of the Social Health Informatics Reporting Engine 150 are Business Process Maps 620. A Business Process Map 620 is a map of the key business processes that are currently performed by the Stakeholder in their every day business. One of the most significant challenges of any data—especially from social media and online platforms—is that the data rarely links back to key metrics and processes of the parties that can benefit from the information. In this case, the business process maps help shape the data to enable a more direct link between Member activity on the service with one or more core business functions of the Stakeholder.

For example, a company that focuses on providing weight loss support may have one function for engaging people in healthier eating, one function for getting members engage in physical exercise, and one group for helping build local community support groups. In such an instance, the Aggregate user Data can be mapped back and categorized in accordance with each of these functions. For example, the healthier eating function may get aggregate data—such as bulletin board posts, questions, and information—that was discussed by connected members relating to healthier eating. This could further include performance data such as the average weight loss experienced by members engaged with their “healthy eating” program as compared with other healthy eating focused stakeholders. This could be further broken down by sub-functions if desired. In this way, the data derived from the site is not only relevant (linked to members they manage) and contextual (derived from the actions and content that they posted) but also actionable as it ties back to a key business process.

The final component of the Social Health Informatics Reporting Engine are the Reporting Templates 630. The Reporting Templates 630 provide a clear and understandable way for the user at the Stakeholder who is accountable for a given business process to receive the data and information tailored to the way they report their data. For example, the reporting template could be derived from a dashboard being used by the group that manages a specific business process. In this way, if a given group or function is being measured by say their ability to increase awareness of a specific incentive program, the reporting template could be configured to aggregate and highlight information that tends to demonstrate the level of user awareness.

Once the data has been mapped to a business process and then organized in accordance with the preferred reporting template, it is combined into a final report 640.

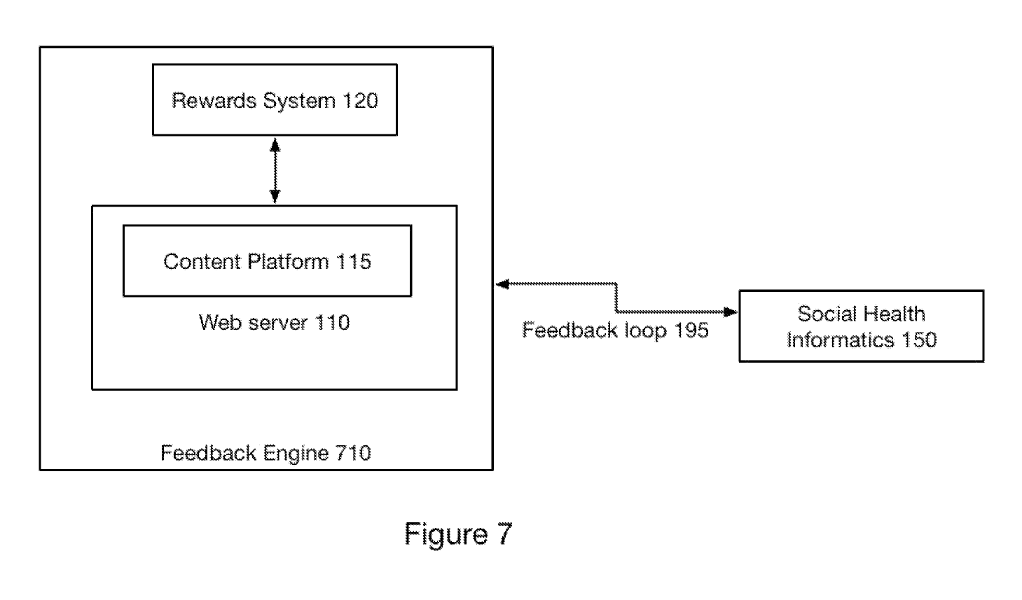

Referring now to FIG. 7, a block diagram illustrating the feedback mechanism of the current invention is shown. The feedback loop 195 effectively connects Social Health Infomatics 150 (and the respective components described with respect to FIG. 6) to the Web Server, 110 and Content Platform 115, and Rewards System 120 that is all linked via a Feedback Engine 710. Essentially, the Feedback Engine 710 filters the Social Health Informatics reported by the Social Health Informatics Reporting Engine 150 and distills it down to one or more metrics that may be linked to a business objective identified by a Stakeholder. For example, if a population manager, such as a care management company, wanted to encourage members to join a contest, the General User Data 610a and Competitive Data 610c previously captured by the Social Health Informatics Reporting Engine 150 could determine that users prefer free mileage over a premium discount as a driver for user adoption. As a result, the Rewards System 120, if adoption is low, this related data could then be used to cause the Rewards System 120 to adjust the incentives accordingly. It would be well understood by those in the art that, with a feedback loop 195 fully enabled, any number of changes could manifest including adjusting relevant content, the positioning of content on the page, personalization of content and associated rewards.

As will be noted, the system and methods of the current invention collectively provide a robust and engaging platform for members, a method for stakeholders to meaningfully (and, if desired, privately) connect and communicate with their members, a content platform for improving awareness of their health as well as the incentives available for their use, and a reporting system for providing tools to help stakeholders optimize their actions and provide a feedback mechanism to provide population managers to implement improved processes, offers and incentives for ultimate impact. In this way, the present invention collectively serves as a remarkable tool for shifting the curve away from cost avoidance and toward better and more meaningful consumer engagement.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as generally set forth in the description above.

I claim:

1) A system for using social tools to managing and measuring member activities comprising:
a. A server that stores one or more content objects including at least one page for enabling member registration;
b. A privacy management module, in communication with the server and member registration pages, that is capable of interpreting one or more fields of data submitted by the member during registration and verifying at least one relationship identified between the member and a third party;
c. A reward system, in communication with the privacy management module and server, that is capable of unlocking one or more content objects on the server for access by the member responsive to the verification of at least one relationship by the privacy management module between a member and a third party; and
d. A reporting engine, in communication with the server and reward system, for collecting and reporting information relating to the actions of the member in response to the unlocked content objects.

2) The system of claim 1, wherein the server stores content objects that are configured for use by a web browser.

3) The system of claim 1, wherein the server stores content objects that are configured for use on a mobile phone.

4) The system of claim 1, wherein the server stores content objects that are configured for use on a tablet.

5) The system of claim 1, wherein the privacy management module is capable of communicating with a third party server when verifying at least one relationship between the member and a third party.

6) The system of claim 1, wherein the privacy management module uses one or more fields in a uniform resource locator used by the member during registration to verify at least one relationship between a member and a third party.

7) The system of claim 1, wherein the privacy management module is capable of verifying that the member is the customer of a health plan.

8) The system of claim 1, wherein the privacy management module is capable of verifying that the member is a patient of a physician.

9) The system of claim 1, wherein the privacy management module is capable of verifying that a member is related to one or more other members.

10) The system of claim 1, wherein the reward system is capable of unlocking a social object that enables the member to communicate with a representative of the third party with whom the member has a relationship.

11) The system of claim 1, wherein the reward system is capable of unlocking a game that can be played by the member via the server.

12) The system of claim 11, wherein the game unlocked by the reward system includes games relating to fitness.

13) The system of claim 12, wherein the fitness game unlocked by the reward system includes receiving one or more communications from a mobile device associated with the member.

14) The system of claim 13, wherein the fitness game receiving communications from a mobile device include communications relating to the location of the member.

15) A method for establishing an anonymous a relationship between a member and a third party comprising the steps of:
a. Providing one more content objects on the internet for use by a member including at least one web page for permitting a member to submit one or more fields of information;
b. Receiving at least one field of data from the member submitted on a web page that can be used to verify a relationship between the member and at least one third party, wherein such data does not include any personally identifiable information about the member;
c. Storing at least one field of data submitted by the member in a database;
d. Receiving at least one field of data from a third party that can be used to verify the relationship between the third party and a member;
e. Validating the relationship between the member and at least one third party by comparing at least one field of data submitted by the member with at least one field of data received from the third party; and
f. responsive to validation that the member is in a relationship with the third party, updating the database to include the relationship between the member and said third party.

16) The method of claim 15, wherein the step of providing one or more content objects on the internet including hosting a web server that hosts one or more web pages including a registration page.

17) The method of claim 16, wherein the step of receiving at least one data field from the member includes receiving data submitted by the member on the registration page.

18) The method of claim 15, wherein the step of receiving at last one data field from the member includes receiving data embedded in a URL that has been selected by the member.

19) The method of claim 15, further comprising the step of, responsive to validation that a member is in a relationship with a third party, providing one or more additional content objects on the internet for use by the member.

20) The method of claim 19, wherein the step of providing one or more additional content objects includes providing at least one contest.

21) The method of claim 19, wherein the step of providing one or more additional content objects includes providing at least one new article.

22) The method of claim 15, wherein the step of receiving at least one field of data from a third party includes receiving data from a health insurance company.

23) The method of claim 15, wherein the step of receiving at least one field of data from a third party includes receiving data from a physician.

24) The method of claim 15, wherein the step of receiving at least one field of data from a member includes receiving data relating to a diagnosis.
